(19) United States
(12) Patent Application Publication
(10) Pub. No.: US 2025/0108376 A1
(43) Pub. Date: Apr. 3, 2025

(54) PARTICLE SEPARATION APPARATUS

(71) Applicants: KYOCERA Corporation, Kyoto-shi (JP); Takazono Corporation, Osaka (JP)

(72) Inventors: Hikaru Funama, Kyoto-shi (JP); Takumi Hasegawa, Osaka (JP)

(73) Assignees: KYOCERA Corporation, Kyoto-shi (JP); Takazono Corporation, Osaka (JP)

(21) Appl. No.: 18/894,229

(22) Filed: Sep. 24, 2024

(30) Foreign Application Priority Data
Sep. 29, 2023 (JP) 2023-169016

(51) Int. Cl. B01L 3/00; B01D 43/00

(52) U.S. Cl. CPC B01L 3/502761; B01D 43/00; B01L 2200/0647; B01L 2300/0864; B01L 2400/0487; B01L 2400/0622

(57) ABSTRACT

A particle separation apparatus includes: a liquid supply unit A; a liquid supply unit B; and a control unit. The liquid supply unit A produces a mixed liquid by mixing the liquid A and a liquid C, and supplies the liquid A to the separation device as the mixed liquid. The control unit controls the liquid supply unit A and the liquid supply unit B to supply the liquid B from the liquid supply unit B to the separation device so as to fill the separation device with the liquid B while producing the mixed liquid by the liquid supply unit A, and supply the liquid A from the liquid supply unit A to the separation device as the mixed liquid after the separation device is filled with the liquid B.

### CROSS REFERENCE TO RELATED APPLICATIONS

This nonprovisional application is based on Japanese Patent Application No. 2023-169016 filed on Sep. 29, 2023 with the Japan Patent Office, the entire contents of which are hereby incorporated by reference.

### BACKGROUND OF THE INVENTION

### Field of the Invention

The present disclosure relates to a particle separation apparatus.

### Description of the Background Art

For example, Japanese Patent Laying-Open No. 2018-158328 discloses a particle separation device for separating a particle in a fluid such as blood. This particle separation device is provided with an inflow port, an outflow port, and a flow path connecting the inflow port and the outflow port. The flow path includes a particle separation structure that separates the particle from the liquid.

### SUMMARY OF THE INVENTION

In the particle separation device described in Japanese Patent Laying-Open No. 2018-158328, it has been required to reduce a time required until the flow of the liquid in the flow path becomes stable to normally separate the particle.

It is an object of the present disclosure to provide a particle separation apparatus so as to reduce a time required to start supplying a sample liquid to a separation device.

A particle separation apparatus according to one aspect of the present disclosure is a particle separation apparatus that separates a particle from a liquid A including the particle by using a separation device configured to separate the particle from the liquid A, the particle separation apparatus including: a liquid supply unit A that supplies the liquid A to the separation device; a liquid supply unit B that supplies a liquid B to the separation device; and a control unit that controls the liquid supply unit A and the liquid supply unit B, wherein the liquid supply unit A produces a mixed liquid by mixing the liquid A and a liquid C, and supplies the liquid A to the separation device as the mixed liquid, and the control unit controls the liquid supply unit A and the liquid supply unit B to supply the liquid B from the liquid supply unit B to the separation device so as to fill the separation device with the liquid B while producing the mixed liquid by the liquid supply unit A, and supply the liquid A from the liquid supply unit A to the separation device as the mixed liquid after the separation device is filled with the liquid B.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view schematically showing a particle separation apparatus according to one embodiment of the present disclosure.

FIG. 2 is a perspective view schematically showing a separation device.

FIG. 3 is a perspective view showing the vicinity of each of a device installation portion and an installation member.

FIG. 4 is a perspective view showing a state in which a needle is engaged with a needle engagement portion.

FIG. 5 is a diagram schematically showing a relation between a control unit and each target controlled by the control unit.

FIG. 6 is a diagram schematically showing a cleaning liquid collection operation for collecting the cleaning liquid from each coupling flow path to each pump.

FIG. 7 is a diagram schematically showing a cleaning liquid storage operation for returning the cleaning liquid from each pump to a cleaning liquid storage portion.

FIG. 8 is a diagram schematically showing a liquid-B replenishment operation for replenishing each pump with a liquid B from a liquid storage portion.

FIG. 9 is a diagram schematically showing a liquid-B filling operation for supplying and filling the separation device with liquid B from each pump.

FIG. 10 is a diagram schematically showing a liquid-B collection operation for collecting liquid B from each coupling flow path to each pump.

FIG. 11 is a diagram schematically showing a liquid-B storage operation for returning liquid B from each pump to the liquid storage portion.

FIG. 12 is a diagram schematically showing a cleaning liquid replenishment operation for replenishing each pump with the cleaning liquid from the cleaning liquid storage portion.

FIG. 13 is a diagram schematically showing a cleaning liquid filling operation for filling each coupling flow path with the cleaning liquid from each pump.

### DESCRIPTION OF THE PREFERRED EMBODIMENTS

Embodiments of the present disclosure will be described with reference to figures. It should be noted that in the below-described figures, the same or corresponding members are denoted by the same reference characters.

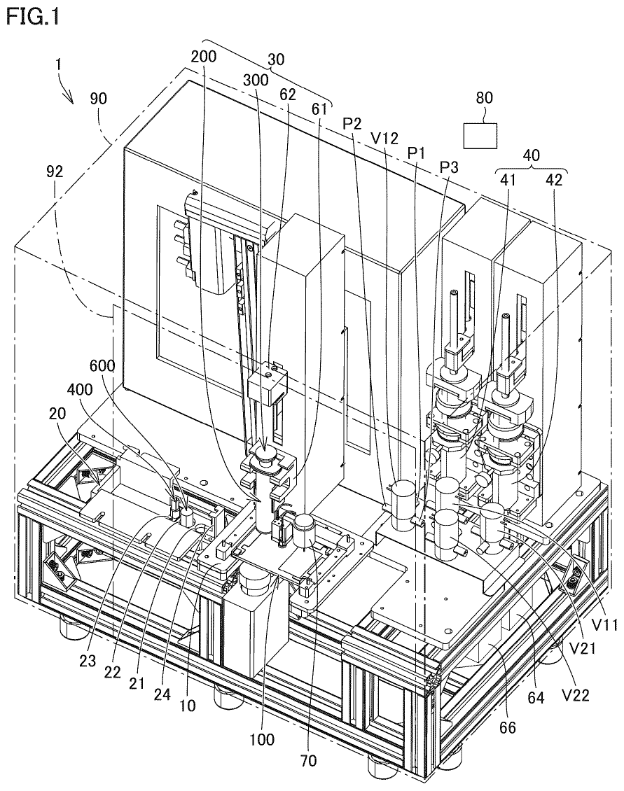

FIG. 1 is a perspective view schematically showing a particle separation apparatus according to one embodiment of the present disclosure. This particle separation apparatus 1 is an apparatus that separates a particle from a liquid A including the particle and serving as a sample liquid by allowing liquid A to flow into a separation device. Particle separation apparatus 1 is preferably used, for example, to separate a white blood cell (particle) from blood.

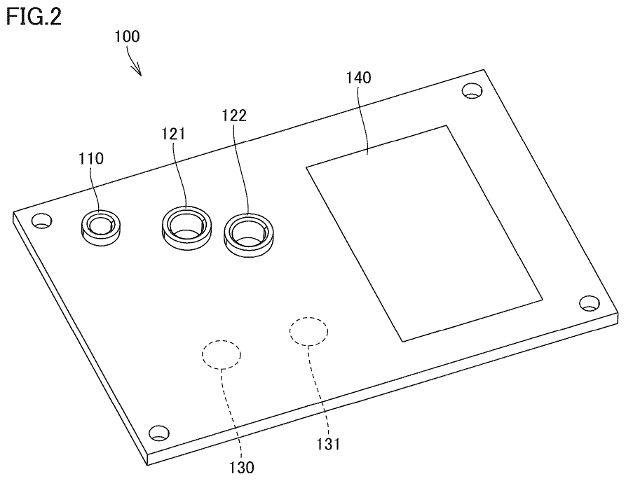

Hereinafter, a separation device 100 will be described first with reference to FIG. 2, and then particle separation apparatus 1 will be described.

Separation device 100 is a device that separates a particle from liquid A including the particle in its flow path. Separation device 100 can, for example, separate a white blood cell from blood. Separation device 100 has a mixed-liquid inflow port 110, a first liquid inflow port 121, a second liquid inflow port 122, a liquid drainage port 130, a collection port 131, and a flow path (not shown) that connects each of liquid inflow ports 110, 121, 122 and liquid drainage port 130 to collection port 131.

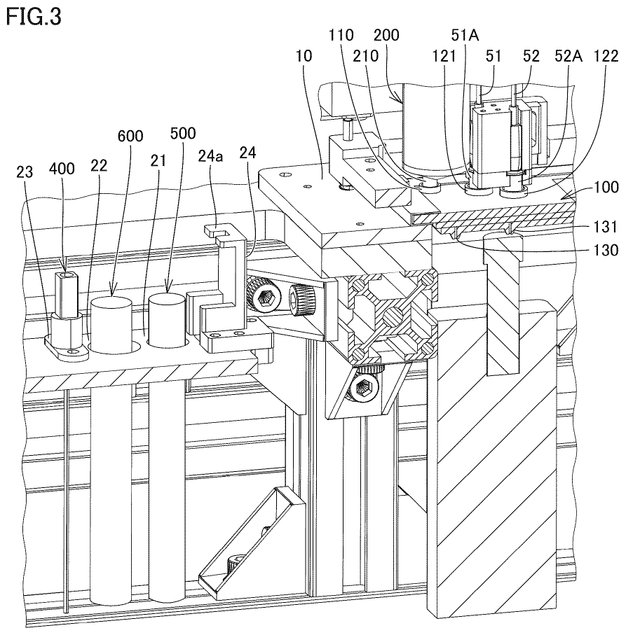

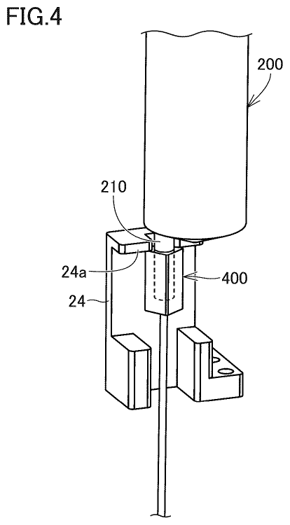

Mixed-liquid inflow port 110 is an inlet (connection port) for allowing liquid A to flow into the flow path as a mixed liquid. The mixed liquid is a mixed liquid of liquid A and a liquid C, which is a solvent for diluting liquid A. When blood is used as liquid A, for example, physiological saline is used as liquid C to dilute the blood, thereby suppressing a plasma component or the like in the blood from being coagulated in the flow path. A discharging portion 210 (see FIGS. 3 and 4) of a syringe 200 is connected to mixed-liquid inflow port 110. Mixed-liquid inflow port 110 is formed in the upper surface of separation device 100.

Each of first liquid inflow port 121 and second liquid inflow port 122 is an inlet (connection port) for allowing a liquid B to flow into the flow path. Liquid B is a liquid that flows into the flow path together with liquid A in order to separate the particle from liquid A. Liquid B is referred to as a buffer liquid or a sheath liquid. One example of liquid B is physiological saline such as phosphate-buffered saline. In the present embodiment, the same liquid is used as liquid B and liquid C. However, liquid B and liquid C may be liquids different from each other. A below-described first coupling flow path 51 is connected to first liquid inflow port 121. A below-described second coupling flow path 52 is connected to second liquid inflow port 122.

Each of liquid inflow ports 121, 122 is formed in the upper surface of separation device 100.

Liquid drainage port 130 is an outlet (opening) for discharging, from inside of the flow path, liquid A (blood including a red blood cell or the like) that has passed through the flow path. Collection port 131 is an opening for discharging, from inside of the flow path, the specific particle (white blood cell) separated from liquid A. Each of liquid drainage port 130 and collection port 131 is formed in the lower surface of separation device 100.

The flow path of separation device 100 includes a separation portion 140 that separates the particle from the mixed liquid having flowed thereinto from mixed-liquid inflow port 110.

As shown in FIG. 1, FIG. 3, or FIG. 5, particle separation apparatus 1 includes a device installation portion 10, an installation member 20, a liquid supply unit A (hereinafter, referred to as “liquid-A supply unit 30”), a liquid supply unit B (hereinafter, referred to as “liquid-B supply unit 40”), a cleaning liquid flow path 56, a liquid storage portion 64, a cleaning liquid storage portion 66, an imaging unit 70, a control unit 80, and a housing 90.

As shown in FIG. 1, housing 90 accommodates device installation portion 10, installation member 20, liquid-A supply unit 30, liquid-B supply unit 40, cleaning liquid flow path 56, liquid storage portion 64, cleaning liquid storage portion 66, imaging unit 70, and control unit 80. Housing 90 may have a window 92 that can be opened and closed. It should be noted that in FIG. 1, housing 90 is indicated by a dot-and-dash line. Further, in FIG. 1, control unit 80 is shown to be located outside housing 90 for the sake of explanation, but is actually disposed inside housing 90.

Device installation portion 10 is a region in which separation device 100 is installed. Device installation portion 10 supports separation device 100 with separation device 100 being in a horizontal posture. In the horizontal posture of separation device 100, mixed-liquid inflow port 110 and liquid inflow ports 121, 122 are opened upward, and liquid drainage port 130 and collection port 131 are opened downward.

Installation member 20 is disposed at a position adjacent to device installation portion 10. Installation member 20 has a liquid container installation portion A (hereinafter, referred to as “liquid-A container installation portion 21”), a liquid container installation portion C (hereinafter, referred to as “liquid-C container installation portion 22”), a needle holding portion 23, and a needle engagement portion 24.

Liquid-A container installation portion 21 is a region in which a liquid container A (hereinafter, referred to as “liquid container 500”) accommodating liquid A is installed. As shown in FIG. 3, liquid container 500 is installed in liquid-A container installation portion 21 in such a posture that the opening thereof faces upward. When blood is used as liquid A, a blood collection tube is used as liquid container 500 (see FIG. 3), for example. The opening of the blood collection tube may be plugged up by a plug body. Liquid-A container installation portion 21 and device installation portion 10 are arranged side by side in the horizontal direction in housing 90.

Liquid-C container installation portion 22 is a region in which a liquid container C (hereinafter, referred to as “liquid container 600”) accommodating liquid C is installed. As shown in FIG. 3, liquid container 600 is installed in liquid-C container installation portion 22 in such a posture that the opening thereof faces upward. In the present embodiment, liquid-C container installation portion 22 is disposed on a horizontal line that connects liquid-A container installation portion 21 and device installation portion 10. Specifically, liquid-C container installation portion 22, liquid-A container installation portion 21, and device installation portion 10 are arranged side by side in this order in the horizontal direction.

Needle holding portion 23 is a region that holds a needle 400 (see FIGS. 3 and 4) to be attached to and detached from discharging portion 210 of syringe 200. Needle holding portion 23 holds a base end portion of needle 400 with needle 400 being in such a posture that the tip thereof faces downward. Needle holding portion 23 is disposed on the horizontal line. Needle holding portion 23 is disposed on a side opposite to the side on which liquid-A container installation portion 21 is disposed with respect to liquid-C container installation portion 22 in the horizontal direction.

Needle engagement portion 24 is a region to be engaged with the needle. Needle engagement portion 24 is disposed on the horizontal line. Needle engagement portion 24 is disposed between liquid-A container installation portion 21 and device installation portion 10 in the horizontal direction. As shown in FIG. 4, needle engagement portion 24 has an engagement piece 24a to be engaged with the base end portion of the needle. Engagement piece 24a regulates needle 400 from being moved together with syringe 200 in a state in which engagement piece 24a is engaged with needle 400 (state shown in FIG. 4). Thus, needle 400 is detached from discharging portion 210.

In the present embodiment, needle holding portion 23, liquid-C container installation portion 22, liquid-A container installation portion 21, needle engagement portion 24, and device installation portion 10 are arranged side by side in this order in the horizontal direction. It should be noted that liquid-A container installation portion 21 and liquid-C container installation portion 22 may be arranged side by side oppositely. In this case, liquid-A container installation portion 21, liquid-C container installation portion 22, and device installation portion 10 are arranged side by side in this order in the horizontal direction. Needle holding portion 23 is disposed on a side opposite to the side on which liquid-C container installation portion 22 is disposed with respect to liquid-A container installation portion 21 in the horizontal direction. Needle engagement portion 24 is disposed between liquid-C container installation portion 22 and device installation portion 10 in the horizontal direction. Therefore, needle holding portion 23, liquid-A container installation portion 21, liquid-C container installation portion 22, needle engagement portion 24, and device installation portion 10 are arranged side by side in this order in the horizontal direction.

Liquid-A-supply unit 30 supplies liquid A to separation device 100. Liquid-A supply unit 30 can produce the mixed liquid by mixing liquid A and liquid C, and can supply the mixed liquid to separation device 100. Liquid-A supply unit 30 has syringe 200, a piston 300, a syringe arm 61, and a piston arm 62.

Syringe arm 61 can grasp syringe 200. Syringe arm 61 can grasp syringe 200 with syringe 200 being in such a posture that discharging portion 210 of syringe 200 faces downward (such a posture that the discharging direction is oriented downward). Syringe arm 61 can move syringe 200 along the above-described horizontal line and can move syringe 200 in the upward/downward direction. Syringe arm 61 moves syringe 200 above needle holding portion 23, liquid-C container installation portion 22, liquid-A container installation portion 21, needle engagement portion 24, and device installation portion 10.

Piston arm 62 can grasp piston 300. Piston arm 62 can push and pull piston 300 toward and from syringe 200. Piston arm 62 can move piston 300 in the upward/downward direction with respect to syringe 200 held by syringe arm 61. Piston arm 62 is moved together with syringe arm 61 while syringe arm 61 is moved.

Liquid-B supply unit 40 supplies liquid B to separation device 100. In the present embodiment, liquid-B supply unit 40 has a first pump 41, a second pump 42, first coupling flow path 51, second coupling flow path 52, a connection arm 63, a liquid flow path 54, and four opening/closing valves V11, V12, V21, V22. It should be noted that in FIGS. 1 and 3, coupling flow paths 51, 52, connection arm 63, and liquid flow path 54 are not shown.

Each of first pump 41 and second pump 42 is constituted of a syringe pump. Each of first pump 41 and second pump 42 is disposed in such a posture that the discharging portion of the syringe faces downward (such a posture that the discharging direction is oriented downward). First pump 41 and second pump 42 are arranged side by side in parallel with the horizontal line.

As shown in FIG. 5, first coupling flow path 51 couples first pump 41 and separation device 100. First coupling flow path 51 couples the discharging portion of the syringe in first pump 41 and first liquid inflow port 121 of separation device 100. As shown in FIG. 3, a seal member 51A is provided at one end of first coupling flow path 51 on the side coupled to separation device 100, thereby increasing airtightness thereof with first liquid inflow port 121. Opening/closing valve V11 (see FIG. 5) is provided in first coupling flow path 51.

Second coupling flow path 52 couples second pump 42 and separation device 100. Second coupling flow path 52 couples the discharging portion of the syringe in second pump 42 and second liquid inflow port 122 of separation device 100. As shown in FIG. 3, a seal member 52A is provided at one end of second coupling flow path 52 on the side coupled to separation device 100, thereby increasing airtightness thereof with second liquid inflow port 122. Opening/closing valve V21 (see FIG. 5) is provided in second coupling flow path 52.

Connection arm 63 (see FIG. 5) can move each of coupling flow paths 51, 52 and can connect each of coupling flow paths 51, 52 to separation device 100. More specifically, connection arm 63 can connect first coupling flow path 51 to first liquid inflow port 121 while grasping first coupling flow path 51, and can connect second coupling flow path 52 to second liquid inflow port 122 while grasping second coupling flow path 52. It should be noted that as described above, connection arm 63 is not shown in FIG. 1.

Liquid storage portion 64 stores liquid B. As shown in FIG. 1, liquid storage portion 64 is disposed below first pump 41 and second pump 42.

Cleaning liquid storage portion 66 stores the cleaning liquid. One example of the cleaning liquid is pure water. As shown in FIG. 1, cleaning liquid storage portion 66 is disposed at a position located below first pump 41 and second pump 42 and adjacent to liquid storage portion 64.

As shown in FIG. 5, liquid flow path 54 has a first flow path 54a branched from first coupling flow path 51 and a second flow path 54b branched from second coupling flow path 52. First flow path 54a couples first coupling flow path 51 and liquid storage portion 64, and one end thereof on the first coupling flow path 51 side is connected to opening/closing valve V11. Second flow path 54b couples second coupling flow path 52 and liquid storage portion 64, and one end thereof on the second coupling flow path 52 side is connected to opening/closing valve V21. Opening/closing valve V12 is provided in first flow path 54a, and opening/closing valve V22 is provided in second flow path 54b. It should be noted that as described above, liquid flow path 54 is not shown in FIG. 1.

As shown in FIG. 5, cleaning liquid flow path 56 has a first cleaning liquid flow path 56a branched from first flow path 54a and a second cleaning liquid flow path 56b branched from second flow path 54b. First cleaning liquid flow path 56a couples first flow path 54a and cleaning liquid storage portion 66, and one end thereof on the first flow path 54a side is connected to opening/closing valve V12. Second cleaning liquid flow path 56b couples second flow path 54b and cleaning liquid storage portion 66, and one end thereof on the second flow path 54b side is connected to opening/closing valve V22. It should be noted that cleaning liquid flow path 56 is not shown in FIG. 1.

Each of first flow path 54a and second flow path 54b is a flow path for liquid B. In first flow path 54a, a flow path that couples opening/closing valve V11 and opening/closing valve V12 is a common flow path for liquid B and the cleaning liquid. In second flow path 54b, a flow path that couples opening/closing valve V21 and opening/closing valve V22 is a common flow path for liquid B and the cleaning liquid.

As shown in FIG. 5, each of opening/closing valves V11, V12, V21, V22 has a first port P1, a second port P2, and a third port P3. Each of opening/closing valves V11, V12, V21, V22 can be switched between a first state and a second state. The first state is a state in which first port Pl and second port P2 are connected to each other. The second state is a state in which first port Pl and third port P3 are connected to each other. Each of opening/closing valves V11, V12, V21, V22 is constituted of an electromagnetic valve. It should be noted that in FIG. 5, a path in the first state is indicated by a solid line and a path in the second state is indicated by a broken line. Further, it means that each of pumps 41, 42 and separation device 100 communicate with each other in FIG. 5.

Imaging unit 70 can capture an image of separation device 100. Imaging unit 70 is disposed, for example, above separation device 100 installed in device installation portion 10.

Control unit 80 controls liquid-A supply unit 30, liquid-B supply unit 40, each of opening/closing valves V11, V12, V21, V22, and imaging unit 70. In particular, control unit 80 controls syringe arm 61 and piston arm 62 of liquid-A supply unit 30, and first pump 41, second pump 42, and connection arm 63 of liquid-B supply unit 40. Control unit 80 performs the following operation. It should be noted that the following operations are exemplary control by control unit 80, and content and order in the control may be changed appropriately.

### [(1) Attaching Needle]

When an instruction to start a separation process is input, control unit 80 controls liquid-A supply unit 30 to attach needle 400 to discharging portion 210 of syringe 200 before producing the mixed liquid in syringe 200. Specifically, control unit 80 performs control to move syringe arm 61 to move syringe 200 to needle holding portion 23, and further moves syringe 200 to attach, to discharging portion 210 of syringe 200, needle 400 held by needle holding portion 23. In the present embodiment, control unit 80 performs control to first move syringe 200 horizontally, position discharging portion 210 of syringe 200 above needle 400 held by needle holding portion 23, then move syringe 200 downward therefrom, and fit discharging portion 210 to the base end portion of needle 400. Thus, needle 400 is connected to syringe 200. Then, syringe 200 having the needle attached thereon is moved upward. It should be noted that when needle 400 is connected to syringe 200 in advance, the operation of attaching needle 400 is omitted.

### [(2) Producing Mixed Liquid]

After attaching needle 400 to syringe 200, control unit 80 controls liquid-A supply unit 30 to produce the mixed liquid in syringe 200 by suctioning liquid A and liquid C into syringe 200. Specifically, control unit 80 performs control to move syringe arm 61 and piston arm 62 so as to move syringe 200 to liquid-C container installation portion 22 and suction liquid C into the syringe, and move syringe 200 to liquid-A container installation portion 21 and suction liquid A into the syringe. Further, control unit 80 may perform control to stir the mixed liquid produced in syringe 200 by discharging the mixed liquid produced in syringe 200 to the outside of syringe 200 and suctioning, into syringe 200, the mixed liquid discharged to the outside of syringe 200. In the present embodiment, control unit 80 performs control to move syringe 200 horizontally so as to position the tip of needle 400 above liquid container 600 installed in liquid-C container installation portion 22, and then move syringe 200 downward therefrom so as to position the tip of needle 400 in liquid container 600. Then, control unit 80 performs control to move (pull up) piston arm 62 to suction liquid C into syringe 200 through needle 400. When an amount of liquid C necessary to dilute liquid A is suctioned into syringe 200, control unit 80 performs control to move syringe 200 upward and position needle 400 above liquid container 600 (outside of liquid container 600). Next, control unit 80 performs control to move syringe 200 horizontally so as to position the tip of needle 400 above liquid container 500 installed in liquid-A container installation portion 21, and then move syringe 200 downward therefrom so as to position the tip of needle 400 in liquid container 500. Then, control unit 80 performs control to move (pull up) piston arm 62 so as to suction liquid A into syringe 200 through needle 400, thereby producing the mixed liquid in syringe 200. Then, in the case of stirring the mixed liquid produced in syringe 200, control unit 80 performs control to discharge, into liquid container 500, the mixed liquid in syringe 200 and suction, into syringe 200, the mixed liquid discharged into liquid container 500, thereby producing a mixed liquid having high homogeneity. The operation of moving piston arm 62 may be repeated a predetermined number of times so as to repeat the discharging and suctioning of the mixed liquid, thereby producing a mixed liquid having higher homogeneity. Then, control unit 80 performs control to move syringe 200 upward so as to position needle 400 above liquid container 500 (outside of liquid container 500).

### [(3) Detaching Needle]

After producing the mixed liquid in syringe 200, control unit 80 controls liquid-A supply unit 30 to detach needle 400 from discharging portion 210 of syringe 200. Specifically, control unit 80 performs control to move syringe 200 so as to engage, with needle engagement portion 24, needle 400 attached to discharging portion 210 of syringe 200, and further moves syringe 200 so as to detach needle 400 from discharging portion 210 with needle 400 being engaged with needle engagement portion 24. In the present embodiment, control unit 80 performs control to move syringe 200 so as to engage, with engagement piece 24a of needle engagement portion 24, the base end portion of needle 400 connected to discharging portion 210, and then moves syringe 200 upward so as to detach needle 400 from discharging portion 210. Needle engagement portion 24 regulates needle 400 from being moved upward together with syringe 200. In this way, needle 400 is detached from discharging portion 210. It should be noted that needle 400 having been detached is collected below needle engagement portion 24.

### [(4) Connecting Syringe to Separation Device]

When needle 400 is detached from discharging portion 210 of syringe 200, control unit 80 controls liquid-A supply unit 30 to connect syringe 200 to separation device 100 installed in device installation portion 10. Specifically, control unit 80 performs control to move syringe arm 61 so as to connect discharging portion 210 of syringe 200 to mixed-liquid inflow port 110 of separation device 100. In the present embodiment, control unit 80 performs control to first move syringe 200 horizontally so as to position discharging portion 210 of syringe 200 above mixed-liquid inflow port 110 of separation device 100, and then move syringe 200 downward therefrom. In this way, discharging portion 210 is connected to mixed-liquid inflow port 110.

[(5) Collecting Cleaning Liquid from Inside of Each Coupling Flow Path]

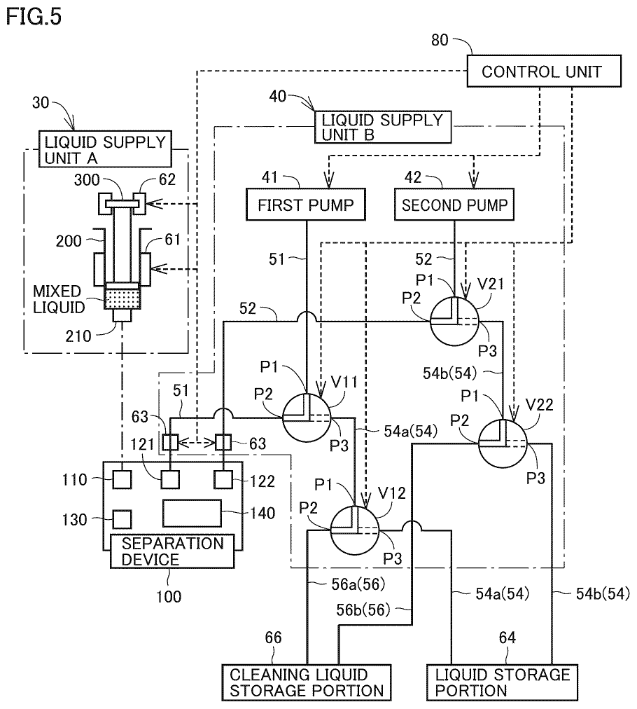

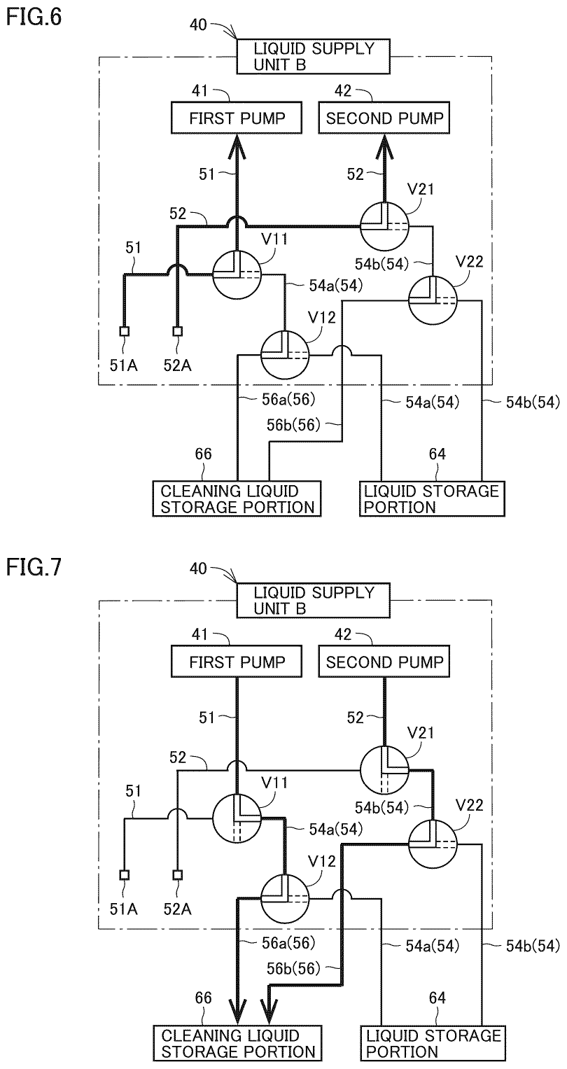

Before particle separation apparatus 1 is activated, each of coupling flow paths 51, 52 is filled with the cleaning liquid. Therefore, when activating particle separation apparatus 1, control unit 80 controls liquid-B supply unit 40 to collect the cleaning liquid inside each of first coupling flow path 51 and second coupling flow path 52. Specifically, in a state in which each of coupling flow paths 51, 52 is detached from separation device 100, control unit 80 performs control to bring opening/closing valve V11 and opening/closing valve V21 into the first state and pull up each of the pistons of pumps 41, 42 so as to collect the cleaning liquid inside each of coupling flow paths 51, 52. FIG. 6 shows a step of collecting the cleaning liquid from each of coupling flow paths 51, 52 to each of pumps 41, 42. It should be noted that in FIG. 6, a region in which the cleaning liquid flows is indicated by a thick line.

### [(6) Storing Cleaning Liquid]

After the cleaning liquid is collected to each of pumps 41, 42, control unit 80 controls liquid-B supply unit 40 to return the cleaning liquid inside each of pumps 41, 42 to cleaning liquid storage portion 66. Specifically, control unit 80 performs control to bring each of opening/closing valve V11 and opening/closing valve V21 into the second state, bring each of opening/closing valve V12 and opening/closing valve V22 into the first state, and push down each of the pistons of pumps 41, 42 so as to return the cleaning liquid inside each of pumps 41, 42 to cleaning liquid storage portion 66. FIG. 7 shows a step of returning the cleaning liquid from each of pumps 41, 42 to cleaning liquid storage portion 66. It should be noted that in FIG. 7, a region in which the cleaning liquid flows is indicated by a thick line.

[(7) Replenishing Each Pump with Liquid B]

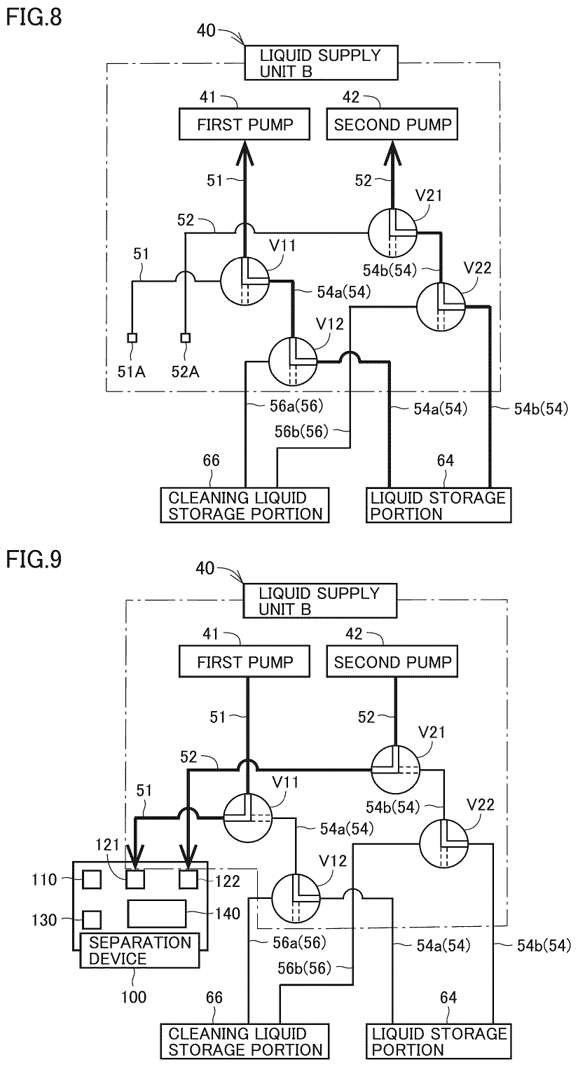

After returning the cleaning liquid inside each of pumps 41, 42 to cleaning liquid storage portion 66, control unit 80 controls liquid-B supply unit 40 to supply liquid B to each of pumps 41, 42. Specifically, control unit 80 performs control to bring all the opening/closing valves V11, V12, V21, V22 into the second state, and pull up each of the pistons of pumps 41, 42 so as to replenish each of pumps 41, 42 with liquid B in liquid storage portion 64. FIG. 8 shows a step of replenishing each of pumps 41, 42 with liquid B from liquid storage portion 64. It should be noted that in FIG. 8, a region in which liquid B flows is indicated by a thick line. When each of pumps 41, 42 is replenished with liquid B, control unit 80 accepts an input of an instruction to start a first separation process after the activation of particle separation apparatus 1.

### [(8) Connecting Liquid Supply Unit B to Separation Device]

When the input of an instruction to start a separation process is accepted, control unit 80 performs control to connect liquid-B supply unit 40 to separation device 100. Specifically, control unit 80 performs control to move connection arm 63 so as to connect first coupling flow path 51 to first liquid inflow port 121 and connect second coupling flow path 52 to second liquid inflow port 122. The connection of each of coupling flow paths 51, 52 to separation device 100 is preferably performed simultaneously with the production of the mixed liquid by liquid-A supply unit 30. Further, the connection of each of coupling flow paths 51, 52 to separation device 100 may be performed simultaneously with the attachment of needle 400 or the detachment of needle 400. It should be noted that when no connection arm 63 is provided, each of coupling flow paths 51, 52 is manually connected to separation device 100.

[(9) Filling Separation Device with Liquid B]

After liquid-B supply unit 40 is connected to separation device 100, control unit 80 controls liquid-B supply unit 40 to supply liquid B from liquid-B supply unit 40 to separation device 100 so as to fill the inside of separation device 100 (flow path of separation device 100) with liquid B, thereby filling the inside of separation device 100 with liquid B. Specifically, control unit 80 performs control to bring each of opening/closing valves V11, V21 into the first state, and push down each of the pistons of pumps 41, 42 so as to supply an amount of liquid B to fill the inside of separation device 100. Liquid B flowing from each of first liquid inflow port 121 and second liquid inflow port 122 reaches mixed-liquid inflow port 110, liquid drainage port 130, and collection port 131. Thus, air is pushed out from the inside of separation device 100, thereby filling the inside of separation device 100 with liquid B. FIG. 9 shows a step of filling separation device 100 with liquid B from each of pumps 41, 42. It should be noted that in FIG. 9, a region in which liquid B flows is indicated by a thick line. The filling of separation device 100 with liquid B is preferably performed simultaneously with at least one of the production of the mixed liquid by liquid-A supply unit 30 and the connection of syringe 200 to separation device 100. Further, it is preferable that each of coupling flow paths 51, 52 is connected to separation device 100 and the filling of separation device 100 with liquid B is started to complete the filling of separation device 100 with liquid B before the production of the mixed liquid or the connection of syringe 200 to separation device 100 is ended.

[(10) Suctioning Liquid B from Inside of Separation Device]

After the inside of separation device 100 is filled with liquid B, control unit 80 controls liquid-A supply unit 30 to suction liquid B from the inside of separation device 100 into syringe 200. Specifically, control unit 80 performs control to pull up piston arm 62 so as to suction liquid B inside separation device 100 into syringe 200 through mixed-liquid inflow port 110. Thus, air existing between discharging portion 210 of syringe 200 and each of liquid inflow ports 121, 122 of separation device 100 is moved to an air phase portion in syringe 200, thereby suppressing the air from remaining in separation device 100.

### [(11) Supplying Mixed Liquid to Separation Device]

After liquid B inside separation device 100 is suctioned into syringe 200, control unit 80 controls liquid-A supply unit 30 to supply liquid A from syringe 200 into separation device 100 as the mixed liquid. Specifically, control unit 80 performs control to push down piston arm 62 so as to supply the mixed liquid from syringe 200 into separation device 100 with discharging portion 210 of syringe 200 being connected to mixed-liquid inflow port 110.

### [(12) Supplying Liquid B to Separation Device]

After liquid B inside separation device 100 is suctioned into syringe 200, control unit 80 performs control to supply liquid A from syringe 200 into separation device 100 and controls liquid-B supply unit 40 to supply liquid B from each of pumps 41, 42 into separation device 100. Specifically, control unit 80 performs control to bring opening/closing valves V11, V21 into the first state and push down each of the pistons of pumps 41, 42 so as to supply liquid B. Thus, liquid B is supplied into separation device 100 together with the mixed liquid. FIG. 9 also shows a step of supplying and filling separation device 100 with liquid B from each of pumps 41, 42.

### [(13) Separating Particle in Separation Device]

When liquid A and liquid B are supplied into separation device 100, the specific particle is separated from liquid A in separation portion 140 of separation device 100, and is discharged from collection port 131 together with liquid B. Further, liquid A from which the specific particle has been separated is discharged from liquid drainage port 130 together with liquid B. When blood is used as liquid A, the white blood cell separated from liquid A is discharged from collection port 131, and the red blood cell and the like are discharged from liquid drainage port 130. On this occasion, control unit 80 controls imaging unit 70 to capture an image of separation device 100 and capture an image of the liquid flowing to liquid drainage port 130 or collection port 131.

### [(14) Detaching Liquid Supply Unit B]

After the separation of the particle in separation device 100 is ended, control unit 80 controls liquid-A supply unit 30 to detach liquid-A supply unit 30 from separation device 100. Specifically, control unit 80 performs control to move syringe arm 61 so as to detach discharging portion 210 of syringe 200 from mixed-liquid inflow port 110 of separation device 100. Also, liquid-B supply unit 40 is detached from separation device 100 manually or by controlling liquid-B supply unit 40. When liquid-B supply unit 40 is detached therefrom by controlling liquid-B supply unit 40, specifically, control unit 80 performs control to move connection arm 63 so as to detach each of coupling flow paths 51, 52 from each of liquid inflow ports 121, 122 of separation device 100.

[(15) Collecting Liquid B from Inside of Each Coupling Flow Path]

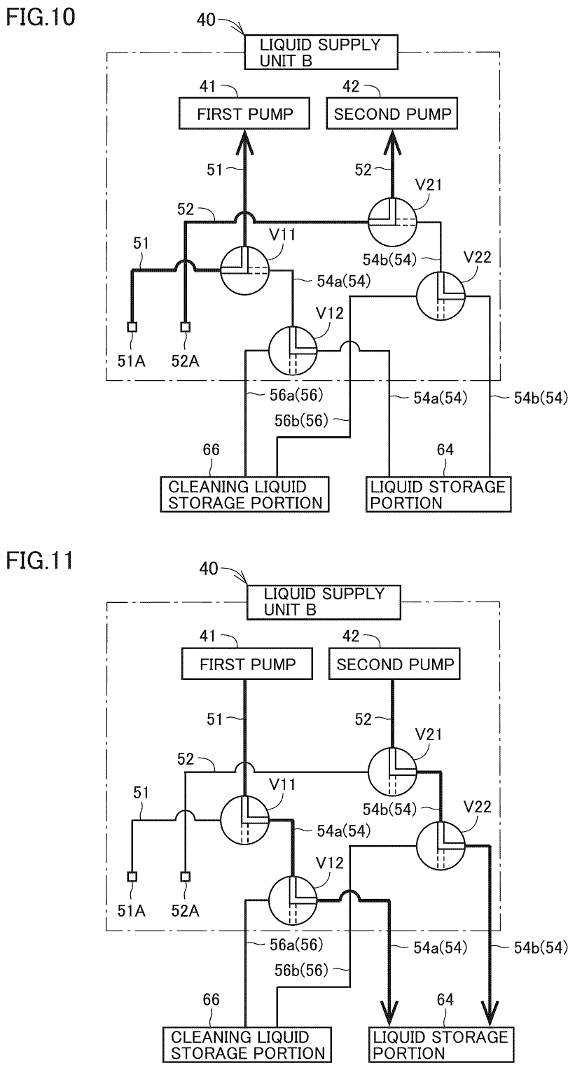

After liquid-B supply unit 40 is detached from separation device 100, control unit 80 controls liquid-B supply unit 40 to collect liquid B inside each of first coupling flow path 51 and second coupling flow path 52. Specifically, in a state in which each of coupling flow paths 51, 52 is detached from separation device 100, control unit 80 performs control to bring opening/closing valve V11 and opening/closing valve V21 into the first state and pull up each of the pistons of pumps 41, 42 so as to collect liquid B inside each of coupling flow paths 51, 52. FIG. 10 shows a step of collecting liquid B from each of coupling flow paths 51, 52. It should be noted that in FIG. 10, a region in which liquid B flows is indicated by a thick line. When liquid B is collected to each of pumps 41, 42, control unit 80 accepts an input of an instruction to start the next separation process.

### [(16) Storing Liquid B]

When an input of turning off the power of particle separation apparatus 1 is accepted, control unit 80 controls liquid-B supply unit 40 to return liquid B inside each of pumps 41, 42 to liquid storage portion 64. Specifically, control unit 80 performs control to bring all the opening/closing valves V11, V12, V21, V22 into the second state and push down each of the pistons of pumps 41, 42 so as to return liquid B inside each of pumps 41, 42 to liquid storage portion 64. FIG. 11 shows a step of returning liquid B from each of pumps 41, 42 to liquid storage portion 64. It should be noted that in FIG. 11, a region in which liquid B flows is indicated by a thick line.

[(17) Replenishing Each Pump with Cleaning Liquid]

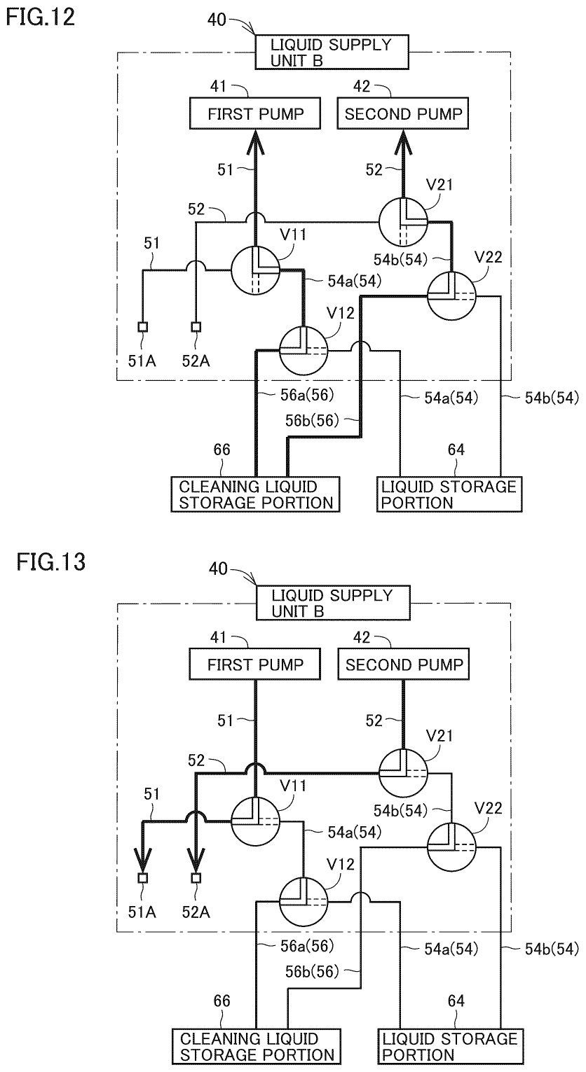

After returning liquid B inside each of pumps 41, 42 to liquid storage portion 64, control unit 80 controls liquid-B supply unit 40 to supply the cleaning liquid to each of pumps 41, 42. Specifically, control unit 80 performs control to bring opening/closing valve V11 and opening/closing valve V21 into the second state, bring opening/closing valve V12 and opening/closing valve V22 into the first state, and pull up each of the pistons of pumps 41, 42 so as to replenish each of pumps 41, 42 with the cleaning liquid in cleaning liquid storage portion 66. FIG. 12 shows a step of replenishing each of pumps 41, 42 with the cleaning liquid from cleaning liquid storage portion 66. It should be noted that in FIG. 12, a region in which the cleaning liquid flows is indicated by a thick line.

[(18) Filling Each Coupling Flow Path with Cleaning Liquid]

After each of pumps 41, 42 is replenished with the cleaning liquid, control unit 80 controls liquid-B supply unit 40 to supply the cleaning liquid to each of coupling flow paths 51, 52. Specifically, control unit 80 performs control to bring opening/closing valve V11 and opening/closing valve V21 into the first state, and push down each of the pistons of pumps 41, 42 so as to fill each of coupling flow paths 51, 52 with the cleaning liquid. Thus, liquid B remaining in each of coupling flow paths 51, 52 is washed away by the cleaning liquid, thereby suppressing clogging of each of coupling flow paths 51, 52. FIG. 13 shows a step of filling each of coupling flow paths 51, 52 with the cleaning liquid from each of pumps 41, 42. It should be noted that in FIG. 13, a region in which the cleaning liquid flows is indicated by a thick line.

As described above, in particle separation apparatus 1 according to the present embodiment, the time required to start supplying the mixed liquid to separation device 100 is reduced.

It should be noted that the stirring of the mixed liquid in syringe 200 may be performed by a method different from the one described above in [(2) Producing Mixed Liquid]. For example, control unit 80 may control liquid-A supply unit 30 to suction air into syringe 200 with liquid A and liquid C being accommodated in syringe 200. Specifically, control unit 80 performs control to pull up piston arm 62 so as to suction air into syringe 200. On this occasion, control unit 80 preferably performs control to suction air into syringe 200 at a rate higher than a rate of suctioning liquid A into syringe 200. That is, when suctioning the air into syringe 200, control unit 80 performs control to pull up piston arm 62 at a rate higher than a rate of pulling up piston arm 62 when suctioning liquid A into syringe 200. Also in this way, the mixed liquid of liquid A and liquid C is effectively produced in syringe 200.

It should be noted that control unit 80 may perform control to suction liquid A and liquid C into syringe 200 in this order or in a reverse order. Further, a prefilled syringe filled with liquid C in advance may be used as syringe 200, and control unit 80 may perform control to suction liquid A into the prefilled syringe. In this case, the step of suctioning liquid C into syringe 200 can be omitted and the mixed liquid can be produced only by suctioning liquid A into syringe 200.

Further, in particle separation apparatus 1 according to the above-described embodiment, there has been described such a configuration that syringe 200 is moved by syringe arm 61 to installation member 20 including device installation portion 10, liquid-A container installation portion 21, and the like; however, there may be employed such a configuration that device installation portion 10 or installation member 20 is moved relative to fixed syringe 200, or there may be employed such a configuration that device installation portion 10, installation member 20, syringe 200, and the like are moved relative to one another.

It is understood by one having ordinary skill in the art that the plurality of exemplary embodiments described above are specific examples of the following aspects.

### [Aspect 1]

A particle separation apparatus that separates a particle from a liquid A including the particle by using a separation device configured to separate the particle from the liquid A, the particle separation apparatus comprising:

a liquid supply unit A that supplies the liquid A to the separation device;

a liquid supply unit B that supplies a liquid B to the separation device; and

a control unit that controls the liquid supply unit A and the liquid supply unit B, wherein

the liquid supply unit A produces a mixed liquid by mixing the liquid A and a liquid C, and supplies the liquid A to the separation device as the mixed liquid, and

the control unit controls the liquid supply unit A and the liquid supply unit B to
supply the liquid B from the liquid supply unit B to the separation device so as to fill the separation device with the liquid B while producing the mixed liquid by the liquid supply unit A, and
supply the liquid A from the liquid supply unit A to the separation device as the mixed liquid after the separation device is filled with the liquid B.

In this particle separation apparatus, the time required to start supplying the liquid A to the separation device is reduced.

### [Aspect 2]

The particle separation apparatus according to aspect 1, wherein the control unit performs control to connect the liquid supply unit A to the separation device while supplying the liquid B from the liquid supply unit B to the separation device so as to fill the separation device with the liquid B.

In this aspect, the time required to start supplying the liquid A to the separation device is further reduced.

### [Aspect 3]

The particle separation apparatus according to aspect 1 or 2, wherein the control unit performs control to connect the liquid supply unit B to the separation device while producing the mixed liquid by the liquid supply unit A.

In this aspect, the time required to start supplying the liquid A to the separation device is further reduced.

### [Aspect 4]

The particle separation apparatus according to aspect 1, wherein

the liquid supply unit B is configured to send out a cleaning liquid, and

the control unit performs control to send out the cleaning liquid from the liquid supply unit B with the liquid supply unit B being detached from the separation device.

In this aspect, since the liquid B remaining in the liquid supply unit B is discharged by sending out the cleaning liquid, occurrence of clogging due to the liquid B remaining in the liquid supply unit B is suppressed.

### [Aspect 5]

A particle separation apparatus that separates a particle from a liquid A including the particle by using a separation device configured to separate the particle from the liquid A, the particle separation apparatus comprising:

a liquid supply unit A that supplies the liquid A to the separation device; and

a control unit that controls the liquid supply unit A, wherein

a syringe is attached to the liquid supply unit A, and the liquid supply unit A produces a mixed liquid by mixing the liquid A and a liquid C in the syringe and supplies the liquid A from the syringe to the separation device as the mixed liquid, and

the control unit performs control to produce the mixed liquid in the syringe by suctioning the liquid A and the liquid C into the syringe.

In this particle separation apparatus, the liquid A and the liquid C are mixed in the syringe, thereby producing the mixed liquid efficiently.

### [Aspect 6]

A particle separation apparatus that separates a particle from a liquid A including the particle by using a separation device configured to separate the particle from the liquid A, the particle separation apparatus comprising:

a liquid supply unit A that supplies the liquid A to the separation device; and

a control unit that controls the liquid supply unit A, wherein

a syringe is attached to the liquid supply unit A, and the liquid supply unit A produces a mixed liquid by mixing the liquid A and a liquid C in the syringe and supplies the liquid A from the syringe to the separation device as the mixed liquid, and

the control unit performs control to produce the mixed liquid in the syringe by suctioning the liquid A into the syringe with the liquid C being accommodated in the syringe.

In this particle separation apparatus, the liquid A and the liquid C are mixed in the syringe, thereby producing the mixed liquid efficiently.

### [Aspect 7]

The particle separation apparatus according to aspect 6, wherein the syringe is a prefilled syringe filled with the liquid C in advance.

### [Aspect 8]

The particle separation apparatus according to any one of aspects 5 to 7, wherein the control unit performs control to discharge, to outside of the syringe, the mixed liquid produced in the syringe and suction, into the syringe, the mixed liquid discharged to the outside of the syringe.

In this aspect, the liquid A and the liquid C are effectively mixed.

### [Aspect 9]

The particle separation apparatus according to any one of aspects 5 to 7, wherein the control unit performs control to suction air into the syringe with the mixed liquid being accommodated in the syringe.

### [Aspect 10]

The particle separation apparatus according to aspect 9, wherein when suctioning the air into the syringe, the control unit performs control to suction the air into the syringe at a rate higher than a rate of suctioning the liquid A into the syringe.

In this aspect, the liquid A and the liquid C are more effectively mixed.

### [Aspect 11]

The particle separation apparatus according to any one of aspects 5 to 7, wherein the control unit performs control to connect the syringe to the separation device after the mixed liquid is produced in the syringe.

### [Aspect 12]

The particle separation apparatus according to aspect 11, further comprising a liquid supply unit B that supplies a liquid B to the separation device, wherein

the control unit controls the liquid supply unit A and the liquid supply unit B to
supply the liquid B from the liquid supply unit B to the separation device so as to fill the separation device with the liquid B, connect the syringe to the separation device, and then suction the liquid B into the syringe from inside of the

In this aspect, air in the separation device is suctioned into the syringe, thereby suppressing the air from remaining in the separation device.

### [Aspect 13]

The particle separation apparatus according to aspect 12, wherein the control unit performs control to suction the liquid B from the inside of the separation device into the syringe, and then supply the liquid A from the syringe to the separation device as the mixed liquid.

In this aspect, since the air in the separation device is released before supplying the liquid A, the liquid A is smoothly supplied into the separation device.

### [Aspect 14]

A particle separation apparatus that separates a particle from a liquid A including the particle by using a separation device configured to separate the particle from the liquid A, the particle separation apparatus comprising:

a liquid supply unit A that supplies the liquid A to the separation device; and

a control unit that controls the liquid supply unit A, wherein

a syringe is attached to the liquid supply unit A, and the liquid supply unit A is configured to move the syringe,

the control unit performs control to
suction the liquid A into the syringe through a needle attached to a discharging portion of the syringe, and
move the syringe to connect the discharging portion of the syringe to the separation device after the liquid A is suctioned into the syringe.

### [Aspect 15]

The particle separation apparatus according to aspect 14, wherein

the liquid supply unit A is configured to detach the needle from the discharging portion of the syringe, and

the control unit performs control to detach the needle from the discharging portion of the syringe before connecting the discharging portion of the syringe to the

### [Aspect 16]

The particle separation apparatus according to aspect 15, wherein the liquid supply unit A includes a needle engagement portion to be engaged with the needle,

the control unit performs control to
move the syringe so as to engage, with the needle engagement portion, the needle attached to the discharging portion of the syringe, and
further move the syringe so as to detach the needle from the discharging portion of the syringe with the needle being engaged with the needle engagement portion.

### [Aspect 17]

The particle separation apparatus according to aspect 14 or 15, wherein the liquid supply unit A is configured to attach the needle to the discharging portion of the syringe, and

the control unit performs control to attach the needle to the discharging portion of the syringe before suctioning the liquid A into the syringe.

### [Aspect 18]

The particle separation apparatus according to aspect 17, wherein

the liquid supply unit A includes a needle holding portion that holds the needle to be attached to the discharging portion of the syringe, and

the control unit performs control to
move the syringe to the needle holding portion, and
further move the syringe so as to attach the needle held by the needle holding portion to the discharging portion of the syringe.

### [Aspect 19]

A particle separation apparatus that separates a particle from a liquid A including the particle by using a separation device configured to separate the particle from the liquid A, the particle separation apparatus comprising:

a device installation portion in which the separation device is installed;

a liquid container installation portion A in which a liquid container A is installed, the liquid container A accommodating the liquid A; and

a syringe arm that grasps a syringe and that moves the syringe above the liquid container installation portion A and the device installation portion, wherein

the device installation portion, the liquid container installation portion A, and the syringe arm are disposed in a housing of the particle separation apparatus, and

the liquid container installation portion A and the device installation portion are arranged side by side in a horizontal direction in the housing of the particle separation apparatus.

In this particle separation apparatus, the liquid container installation portion A and the device installation portion are arranged side by side in the horizontal direction, and the syringe is moved above these, thus resulting in a reduced size of the housing of the apparatus.

### [Aspect 20]

The particle separation apparatus according to aspect 19, further comprising a liquid container installation portion C in which a liquid container C is installed, the liquid container C accommodating a liquid C to be mixed with the liquid A so as to produce a mixed liquid, wherein

the liquid container installation portion C is disposed in the housing of the particle separation apparatus,

the liquid container installation portion C, the liquid container installation portion A, and the device installation portion are arranged side by side in this order in the horizontal direction.

### [Aspect 21]

The particle separation apparatus according to aspect 20, further comprising a needle engagement portion to be engaged with a needle attached to the syringe so as to detach the needle from the syringe, wherein

the needle engagement portion is disposed in the housing of the particle separation apparatus, and

the needle engagement portion is disposed between the liquid container installation portion A and the device installation portion in the horizontal direction.

### [Aspect 22]

The particle separation apparatus according to aspect 21, further comprising a needle holding portion that holds the needle to be attached to the syringe, wherein

the needle holding portion is disposed in the housing of the particle separation apparatus, and

the needle holding portion is disposed on a side opposite to a side on which the liquid container installation portion A is disposed with respect to the liquid container installation portion C in the horizontal direction.

### [Aspect 23]

The particle separation apparatus according to aspect 19, further comprising a liquid container installation portion C in which a liquid container C is installed, the liquid container C accommodating a liquid C to be mixed with the liquid A so as to produce a mixed liquid, wherein

the liquid container installation portion C is disposed in the housing of the particle separation apparatus, and

the liquid container installation portion A, the liquid container installation portion C, and the device installation portion are arranged side by side in this order in the horizontal direction.

### [Aspect 24]

The particle separation apparatus according to aspect 23, further comprising a needle engagement portion to be engaged with the needle so as to detach, from the syringe, the needle attached to the syringe, wherein

the needle engagement portion is disposed in the housing of the particle separation apparatus, and

the needle engagement portion is disposed between the liquid container installation portion C and the device installation portion in the horizontal direction.

### [Aspect 25]

The particle separation apparatus according to aspect 24, further comprising a needle holding portion that holds the needle to be attached to the syringe, wherein

the needle holding portion is disposed on a side opposite to a side on which the liquid container installation portion C is disposed with respect to the liquid container installation portion A in the horizontal direction.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A particle separation apparatus that separates a particle from a liquid A including the particle by using a separation device configured to separate the particle from the liquid A, the particle separation apparatus comprising:
a liquid supply unit A that supplies the liquid A to the separation device;
a liquid supply unit B that supplies a liquid B to the separation device; and
a control unit that controls the liquid supply unit A and the liquid supply unit B, wherein
the liquid supply unit A produces a mixed liquid by mixing the liquid A and a liquid C, and supplies the liquid A to the separation device as the mixed liquid, and
the control unit controls the liquid supply unit A and the liquid supply unit B to
supply the liquid B from the liquid supply unit B to the separation device so as to fill the separation device with the liquid B while producing the mixed liquid by the liquid supply unit A, and
supply the liquid A from the liquid supply unit A to the separation device as the mixed liquid after the separation device is filled with the liquid B.

2. The particle separation apparatus according to claim 1, wherein the control unit performs control to connect the liquid supply unit A to the separation device while supplying the liquid B from the liquid supply unit B to the separation device so as to fill the separation device with the liquid B.

3. The particle separation apparatus according to claim 1, wherein the control unit performs control to connect the liquid supply unit B to the separation device while producing the mixed liquid by the liquid supply unit A.

4. The particle separation apparatus according to claim 1, wherein
the liquid supply unit B is configured to send out a cleaning liquid, and
the control unit performs control to send out the cleaning liquid from the liquid supply unit B with the liquid supply unit B being detached from the separation device.
